(19) United States
(12) Patent Application Publication
(10) Pub. No.: US 2013/0259306 A1
(43) Pub. Date: Oct. 3, 2013

(54) AUTOMATIC REVOLVING DOOR AND AUTOMATIC REVOLVING DOOR CONTROL METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/831,875

(22) Filed: Mar. 15, 2013

(30) Foreign Application Priority Data
Mar. 29, 2012 (TW) 101111199

(51) Int. Cl. E05F 15/20

(52) U.S. Cl. CPC E05F 15/203
USPC 382/103; 382/106

(57) ABSTRACT

An exemplary automatic revolving door control method includes obtaining a preset number of successive images captured by a camera. The images include distance information by TOF technology of the objects captured in the images. The method creates successive 3D scene models. Next, the method determines whether one or more persons appear in the created successive 3D scene models. The method further includes determining a foremost person of the one or more person as a person being monitored, and determines whether the moving direction of the person being monitored is toward the entrance. The method determines the moved distance by the person being monitored in the two created 3D scene models. The method determines the moving time taken for the calculated moved distance, and further determines the moving speed of the person being monitored, to rotate the automatic revolving door at a speed to match that of the person being monitored.

### BACKGROUND

1. Technical Field

The present disclosure relates to automatic revolving doors, and particularly, to an automatic revolving door capable of adjusting the rotation speed and an automatic revolving door control method.

2. Description of Related Art

An automatic revolving door rotates with a preset speed when a person passes through the automatic revolving door. However, the automatic revolving door can not automatically adjust the rotation speed according to a moving speed of the person, which may bring harm to the person. Thus, an automatic revolving door is desirable to resolve the above problem.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram illustrating an automatic revolving door, in accordance with an exemplary embodiment.

FIG. 2 is a schematic view of the automatic revolving door of the FIG. 1.

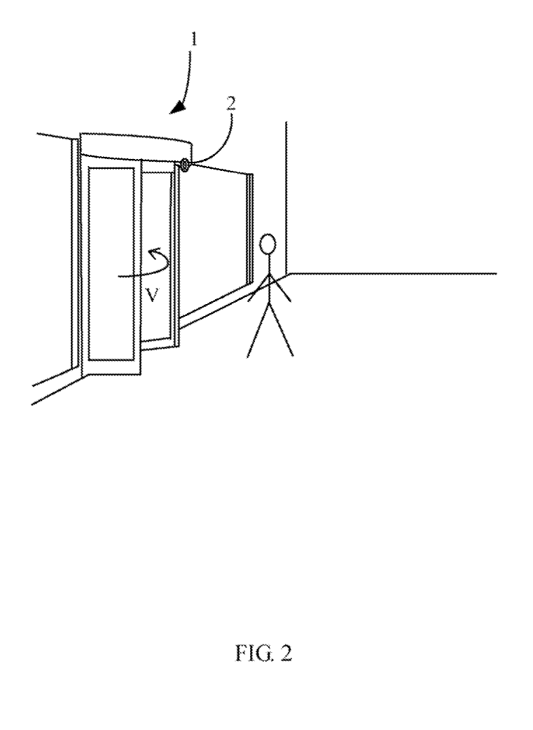

FIG. 3 is a schematic view showing how to determine a moved distance by the person being monitored in two created 3D scene models.

FIG. 4 is a flowchart of an automatic revolving door control method, in accordance with an exemplary embodiment.

FIG. 5 is a flowchart of steps S404-S407 of FIG. 4.

### DETAILED DESCRIPTION

The embodiments of the present disclosure are described with reference to the accompanying drawings.

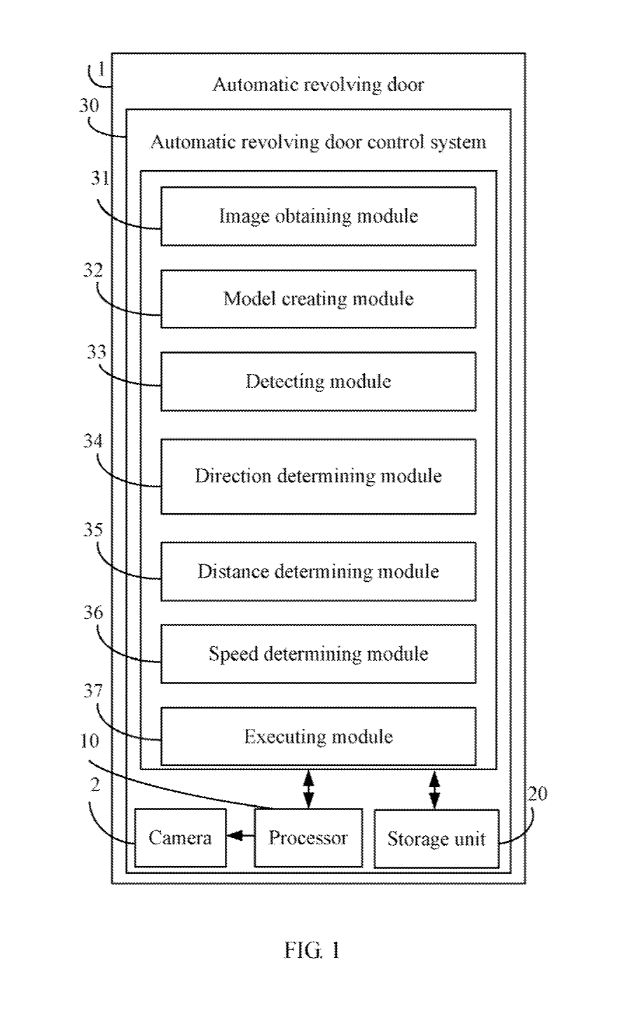

FIG. 1 is a schematic diagram illustrating an automatic revolving door 1 which can rotate to match the speed of a person passing through the automatic revolving door 1. The automatic revolving door 1 includes at least one camera 2. In the embodiment, two cameras 2 are employed to illustrate the disclosure. The automatic revolving door 1 can analyze a preset number of successive images captured by each of the cameras 2, determine whether a person appears in each of the preset number of successive images, determine the moving speed of the person, and further rotate with the determined moving speed of the person.

Each captured image shot by each camera 2 includes distance information indicating the distance between each camera 2 and any object in the field of view of the corresponding camera 2. In the embodiment, each camera 2 is a Time of Flight (TOF) camera. The two cameras 2 are arranged on opposite sides of the entrance of the automatic revolving door 1 and face opposite directions, and only one camera 2 is shown.

The automatic revolving door 1 includes a processor 10, a storage unit 20, and an automatic revolving door control system 30. In the embodiment, the automatic revolving door control system 30 includes an image obtaining module 31, a model creating module 32, a detecting module 33, a direction determining module 34, a distance determining module 35, a speed determining module 36, and an executing module 37. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. The storage unit 20 further stores a number of three-dimensional (3D) models of persons, a vertical distance between the camera 2 and the ground, and a shooting speed of the camera 2. Each 3D model of a person has a number of characteristic features. The 3D person models may be created based on a number of person images pre-collected by the camera 2 and the distances between the camera 2 and the person recorded in the pre-collected images of persons.

The image obtaining module 31 is configured to obtain a preset number of successive images captured by each camera 2.

The model creating module 32 is configured to create successive 3D scene models corresponding to each camera 2 according to the preset number of successive images captured by each camera 2, and the distances between each camera 2 and any object in the field of view of the camera 2.

The detecting module 33 is configured to determine whether one or more persons appear in the created successive 3D scene models corresponding to each camera 2. In detail, the detecting module 33 is configured to extract data from each created successive 3D scene model corresponding to each camera 2, the data corresponding to the shape of the one or more objects appearing in the created 3D scene model, and compare each of the extracted data from each created successive 3D scene model corresponding to each camera 2 with characteristic features of each of the 3D models of persons, to determine whether one or more persons appear in the created successive 3D scene models corresponding to each camera 2. If at least one extracted data from each successive 3D scene model corresponding to each camera 2 matches the characteristic features of any one of the 3D models of persons, the detecting module 33 is configured to determine that one or more persons do appear in the created successive 3D scene models corresponding to each camera 2. If the least one extracted data from each successive 3D scene model corresponding to one camera 2 matches the characteristic features of any one of the 3D models of persons, the detecting module 33 is configured to determine that one or more persons appear in the created successive 3D scene models corresponding to one camera 2. Otherwise, the detecting module 33 is configured to determine that no body appears in the created successive 3D scene models corresponding to any camera 2.

When one or more persons appear in the created successive 3D scene models corresponding to each camera 2, the direction determining module 34 determines which one of the people, or the person if only one, is foremost and thus closest to the automatic revolving door 1 to be a person being monitored. The direction determining module 34 is configured to determine whether the height of the person being monitored in the created successive 3D scene models corresponding to each camera 2 gradually increases. If the height of the person being monitored in the created successive 3D scene models corresponding to each camera 2 gradually increases, the direction determining module 34 is configured to determine that the moving direction of the person being monitored corresponding to each camera 2 is toward the entrance of the automatic revolving door 1. If the height of each person being monitored in the created successive 3D scene models corresponding to one camera 2 gradually increases, the direction determining module 34 is configured to determine that the moving direction of the person being monitored corresponding to one camera 2 is toward the entrance of the automatic revolving door 1.

For example, person A appears in the created successive 3D scene models corresponding to the camera G and person B appears in the created successive 3D scene models corresponding to the camera H. When the direction determining module 34 determines the height of the person A in the created successive 3D scene models corresponding to the camera G and the height of the person B in the created successive 3D scene models corresponding to the camera H gradually increases, the direction determining module 34 determines the moving direction of the person A and the moving direction of the person B are both toward the entrance. When the direction determining module 34 determines that the height of only the person A in the created successive 3D scene models corresponding to the camera G increases, the direction determining module 34 determines the moving direction of only the person A is toward the entrance.

If one or more persons appear in the created successive 3D scene models corresponding to one camera 2, the direction determining module 34 is configured to determine the person who is foremost to be a person being monitored. The direction determining module 34 is further configured to determine whether the height of the person being monitored in the created successive 3D scene models corresponding to one camera 2 gradually increases. If the height of the person being monitored in the created successive 3D scene models corresponding to one camera 2 gradually increases, the direction determining module 34 is configured to determine that the moving direction of the person being monitored corresponding to one camera 2 is toward the entrance.

For example, person C appears in the created successive 3D scene models corresponding to the camera I and nobody appears in the created successive 3D scene models corresponding to the camera J. When the direction determining module 34 determines that the height of the person C in the created successive 3D scene models corresponding to the camera I gradually increases, the direction determining module 34 determines that the moving direction of the person C is toward the entrance.

When the moving direction of the person being monitored corresponding to each camera 2 is toward the entrance, the distance determining module 35 is configured to determine the distance between a foot of the person being monitored and the monitoring camera 2, and determine the horizontal distance between the person and the monitoring camera 2 according to the formula: Z=(Y²−X²)^{1/2}, where Z represents the horizontal distance between the person being monitored and the monitoring camera 2; Y represents the distance between a foot of the person being monitored and the monitoring camera 2; and X represents the vertical distance between the camera 2 and the ground. The distance determining module 35 is further configured to determine the shorter horizontal distance between the person being monitored and the monitoring camera 2 from the determined horizontal distances, and determine the successive 3D scene models corresponding to one camera 2 according to the shorter horizontal distance between the person being monitored and monitoring camera 2. Thus, the automatic revolving door control system 30 can analyze the successive 3D scene models corresponding to one camera 2 to control the automatic revolving door 1 to rotate according to the person who is in fact nearest to the automatic revolving door 1.

For example, the moving direction of the person D corresponding to the camera K and the moving direction of the person E corresponding to the camera L are both toward the entrance. When the distance determining module 35 determines the horizontal distance between the person D being monitored and the camera K is 0.5 meters and the horizontal distance between the person E being monitored and the camera L is 1 meter, the distance determining module 35 determines that the horizontal distance between the person D and the camera K is shorter, and thus determines the successive 3D scene models corresponding to the camera K.

The distance determining module 35 is thus configured to select any two created 3D scene models from the created successive 3D scene models corresponding to one camera 2, determine a distance between the camera 2 and the foot of the person being monitored included in each two selected 3D scene models, and determine a distance between the person being monitored and the entrance in each two selected 3D scene models according to the formula: β=(α²−X²)^{1/2}, where β represents the distance between the person being monitored and the entrance in each two selected 3D scene models; α represents the distance between the camera 2 and the foot of the person being monitored included in each two selected 3D scene models; and X represents the vertical distance between the camera 2 and the ground. The distance determining module 35 is further configured to determine that the moved distance by the person being monitored in the two selected 3D scene models is the absolute value of the difference (the subtraction) of two determined distances between the person being monitored in each two selected 3D scene models and the entrance.

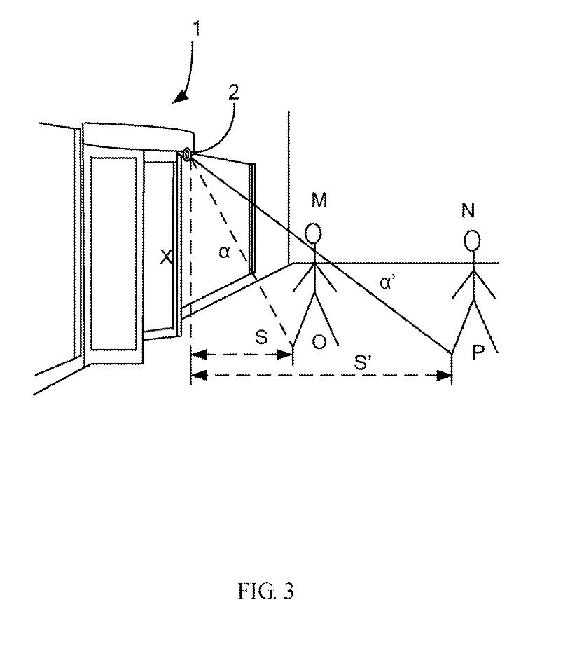

For example, as in FIG. 3, in selected 3D scene model M, the position of a first person is O and in selected 3D scene model N the position of the same person is P. When the distance determining module 35 determines the distance between the first person being monitored of selected 3D scene model M and the entrance is 0.8 meters and the distance between the same person being monitored of selected 3D scene model N and the entrance is 1.8 meters, the distance determining module 35 determines that the moved distance by the first person being monitored in the selected 3D scene model M and the selected 3D scene model N is equal to subtracting 0.8 meters from 1.8 meters, thus the moved distance by the first person being monitored between the selected scene model M and the selected 3D scene model N is 1 meter.

When the moving direction of the person being monitored corresponding to one camera 2 is toward the entrance, the distance determining module 35 is configured to omit the aforementioned operation of determining the shorter horizontal distance and determining the successive 3D scene models, and only execute the aforementioned operation of determining the moved distance by the person being monitored in the two selected 3D scene models.

The speed determining module 36 is configured to divide the stored shooting speed of the camera from the number of 3D scene models between the determined two selected 3D scene models, to determine a moving time passed while a person being monitored moves the moved distance, and further determine the moving speed of the person being monitored according to the formula: V=S/T, where V represents the moving speed of the person being monitored; S represents the moved distance by the person being monitored in the two created 3D scene models; and T represents the moving time of the person being monitored.

The executing module 37 is configured to control the automatic revolving door 1 to rotate to match the determined moving speed of the person. Thus, the rotation speed of the automatic revolving door 1 is the same as the moving speed of the person who passes through the automatic revolving door 1, which not only prevents the person from being harmed by the automatic revolving door 1, but also promotes the fastest and most efficient throughput of employees and others.

When the number of the cameras 2 is one, the image obtaining module 31 is configured to only obtain a preset number of successive images captured by the camera 2. The model creating module 32 creates successive 3D scene models corresponding to one camera 2. The detecting module 33 is configured to only determine whether one or more persons appear in the created successive 3D scene models corresponding to one camera 2. Thus, the direction determining module 34 is configured to only executes the operation of determining if one or more persons appear in the created successive 3D scene models corresponding to one camera 2 to determine whether the moving direction of the person being monitored corresponding to the single camera 2 is toward the entrance. The distance determining module 35 is configured to omit the aforementioned operation of determining the shorter horizontal distance and determining the successive 3D scene models, only executing the aforementioned operation of determining the moved distance by the person being monitored in the two created 3D scene models. The speed determining module 36 is configured to execute the aforementioned operation of determining the moving speed of the person being monitored and the executing module 37 is configured to execute the aforementioned operation of controlling the automatic revolving door 1 to rotate.

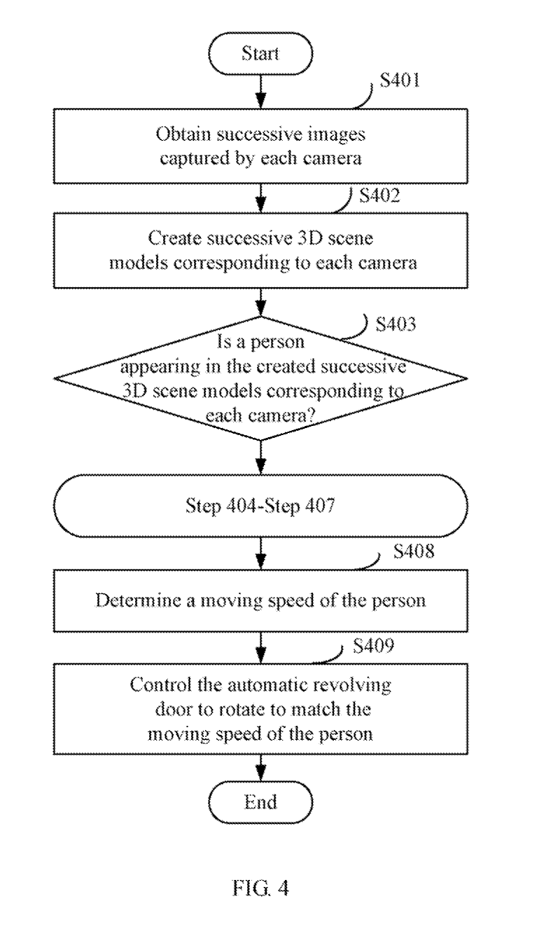

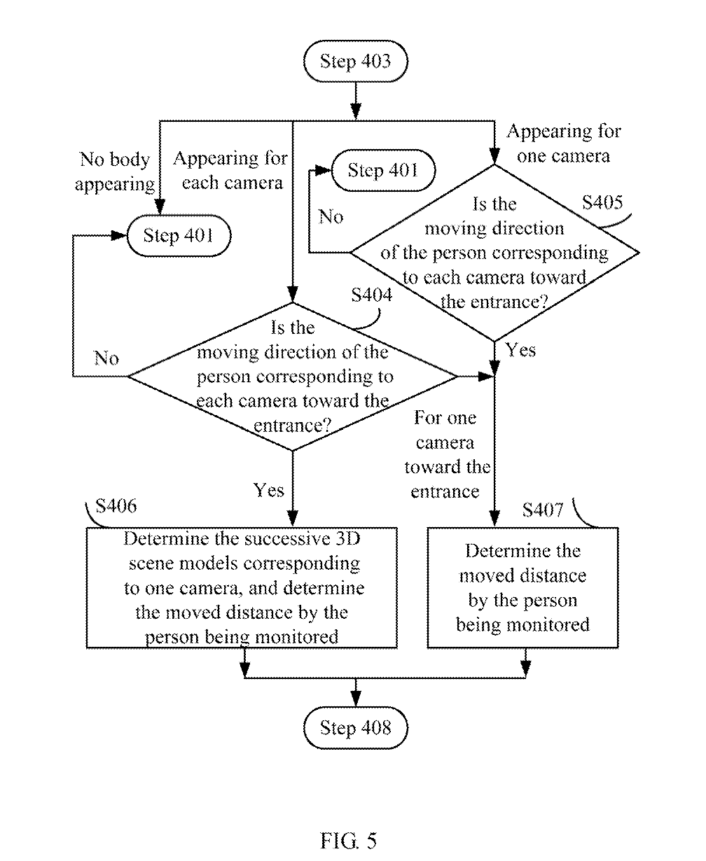

FIGS. 4-5 show a flowchart of an automatic revolving door control method in accordance with an exemplary embodiment.

In step S401, the image obtaining module 31 obtains a preset number of successive images captured by each camera 2.

In step S402, the model creating module 32 creates successive 3D scene models corresponding to each camera 2 according to the preset number of successive images captured by each camera 2 and the distances between each camera 2 and any object in the field of view of a camera 2.

In step S403, the detecting module 33 determines whether one or more persons appear in the created successive 3D scene models corresponding to each camera 2. When one or more persons appear in the created successive 3D scene models corresponding to each camera 2, the procedure goes to step S404. When one or more persons appear in the created successive 3D scene models corresponding to one camera 2, the procedure goes to step S405. When no body appears in the created successive 3D scene models corresponding to any camera 2, the procedure remains at step S401.

In detail, the detecting module 33 extracts data from each created successive 3D scene model corresponding to each camera 2 corresponding to the shape of the one or more objects appearing therein, and compares each of the extracted data from each created successive 3D scene model corresponding to each camera 2 with characteristic features of each of the 3D models of persons, to determine whether one or more persons appear in the created successive 3D scene models corresponding to each camera 2. If at least one extracted data from each successive 3D scene model corresponding to each camera 2 substantially matches the characteristic features of any one of the 3D models of persons, the detecting module 33 determines that one or more persons appear in the created successive 3D scene models corresponding to each camera 2. If the least one extracted data from each successive 3D scene model corresponding to one camera 2 matches the characteristic features of any one of the 3D models of persons, the detecting module 33 determines that one or more persons appear in the created successive 3D scene models corresponding to one camera 2. Otherwise, the detecting module 33 determines that no body appears in the created successive 3D scene models corresponding to any camera 2.

In step S404, the direction determining module 34 determines a foremost person in the one or more person as a person being monitored, determines whether the moving direction of the person being monitored corresponding to each camera 2 is toward the entrance. If the moving direction of the person being monitored corresponding to each camera 2 is toward the entrance, the procedure goes to step S406. If the moving direction of the person being monitored corresponding to one camera 2 is toward the entrance, the procedure goes to step S407. If the moving direction of person being monitored corresponding to any camera 2 is not toward the entrance, the procedure returns to step S401.

In detail, the direction determining module 34 determines whether the height of the person being monitored in the created successive 3D scene models corresponding to each camera 2 gradually increases. If the height of the person being monitored in the created successive 3D scene models corresponding to each camera 2 gradually increases, the direction determining module 34 determines that the moving direction of the person being monitored corresponding to each camera 2 is toward the entrance. If the height of each person being monitored in the created successive 3D scene models corresponding to one camera 2 gradually increases, the direction determining module 34 determines that the moving direction of the person being monitored corresponding to one camera 2 is toward the entrance.

In step S405, the direction determining module 34 determines a foremost person of the one or more persons as the person being monitored, determines whether the moving direction of the person being monitored corresponding to one camera 2 is toward the entrance. If the moving direction of the person being monitored corresponding to one camera 2 is toward the entrance, the procedure goes to step S407. If the moving direction of the person being monitored corresponding to one camera 2 is not toward the entrance, the procedure returns to step S401.

In step S406, the distance determining module 35 determines the distance between a foot of the person being monitored and the monitoring camera 2, determines a horizontal distance between the person being monitored and the monitoring camera 2 according to the formula: Z=(Y²−X²)^{1/2}, where Z represents the horizontal distance between the person being monitored and the monitoring camera 2; Y represents the distance between the foot of the person being monitored and the monitoring camera 2; and X represents the vertical distance between the monitoring camera 2 and the ground. The distance determining module 35 further determines the shorter horizontal distance between the person being monitored and the monitoring camera 2 from the determined horizontal distance, and determines the successive 3D scene models corresponding to one camera 2 according to the shorter horizontal distance between the person being monitored and the monitoring camera 2. The distance determining module 35 selects any two created 3D scene models from the created successive 3D scene models corresponding to one camera 2, determines a distance between the camera 2 and the foot of the person being monitored included in each two selected 3D scene models. The distance determining module 35 further determines a distances between the person being monitored and the entrance in each two selected 3D scene models according to the formula: β=(α²−X²)^{1/2}, where β represents the distance between the person being monitored and the entrance in each two selected 3D scene models; α represents the distance between the camera 2 and the foot of the person being monitored included in each two selected 3D scene models; and X represents the vertical distance between the camera 2 and the ground. The distance determining module 35 further determines that the distance moved by the person being monitored in the two selected 3D scene models is the absolute value of the difference (the subtraction) of the two determined distances between the person being monitored in each two selected 3D scene models and the entrance.

In step S407, the distance determining module 35 selects any two created 3D scene models from the created successive 3D scene models, determines the distances between the camera 2 and the foot of the person being monitored which is included in each of two selected 3D scene models. The distance determining module 35 further determines the distance between the person being monitored and the entrance in each of two selected 3D scene models, according to the formula: β=(α²−X²)^{1/2}, where β represents the distance between the person being monitored and the entrance in each two created 3D scene models; α represents the distance between the camera 2 and the foot of the person being monitored included in each two selected 3D scene models; and X represents the vertical distance between the camera 2 and the ground. The distance determining module 35 further determines that the distance moved by the person being monitored in the two selected 3D scene models is the absolute value of the difference (the subtraction) of two determined distances between the person being monitored and the entrance in each two selected 3D scene models.

In step S408, the speed determining module 36 divides the stored shooting speed of the camera from the number of 3D scene models generated between the determined two selected 3D scene models, to determine a moving time within which the determined moved distance took place, and further determines the moving speed of the person being monitored according to the formula: V=S/T.

In step S409, the executing module 37 controls the automatic revolving door 1 to rotate to match the determined moving speed of the person being monitored.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. An automatic revolving door comprising:
at least one camera;
a storage unit;
a processor;
one or more programs stored in the storage unit, executable by the processor, the one or more programs comprising:
an image obtaining module operable to obtain a preset number of successive images captured by each of the at least one camera, the images comprising a distance information indicating distances between each of the at least camera and objects captured by the corresponding camera;
a model creating module operable to create successive 3D scene models corresponding to each of the at least one camera according to the preset number of successive images captured by each of the at least one camera and the distances between each of the at least one camera and any object in the field of view of the corresponding camera;
a detecting module operable to determine whether one or more persons appear in the created successive 3D scene models corresponding to each of the at least one camera according to stored 3D models of persons;
a direction determining module operable to determine a foremost person of the one or more persons to be a person being monitored when the one or more persons appear in the created successive 3D scene models corresponding to at least one camera, and determine whether the moving direction of the person being monitored corresponding to at least one camera is toward an entrance of the automatic revolving door according to the created successive 3D scene models corresponding to at least one camera;
a distance determining module operable to determine the successive 3D scene models corresponding to one camera when the moving direction of the person being monitored corresponding to at least one camera is toward an entrance of the automatic revolving door, select any two created 3D scene models from the created successive 3D scene models corresponding to the camera, determine a distance between the camera and a foot of the person being monitored included in each of the two selected 3D scene models, and determine a distance between the person being monitored and the entrance in each of the two selected 3D scene models according to the formula: β=(α²−X²)^{1/2}, where β represents the distance between the person being monitored in each of the two selected 3D scene models and the entrance; α represents the distance between the camera and the foot of the person being monitored included in each of the two selected 3D scene models; and X represents a stored vertical distance between the camera and the ground; the distance determining module further being operable to determine the moved distance by the person being monitored in the two selected 3D scene models being the absolute value of the difference of two determined distances between the person being monitored of each two selected 3D scene models and the entrance;
a speed determining module operable to determine a moving time passed while the person being monitored moves the moved distance according to the number of 3D scene models between the two selected 3D scene models and a stored shooting speed of the camera, and further determine the moving speed of the person being monitored according to the formula: V=S/T, where V represents the moving speed of the person being monitored; S represents the moved distance by the person being monitored in the two selected 3D scene models; T represents the moving time of the person being monitored; and
an executing module operable to control the automatic revolving door to rotate to match the determined moving speed of the person being monitored.

2. The automatic revolving door as described in claim 1, wherein the number of the at least one camera is two and the two cameras respectively face opposite directions, and the moving direction determining module is operable to:
determine whether the height of the person being monitored in the created successive 3D scene models corresponding to each camera gradually increases when one or more persons appear in the created successive 3D scene models corresponding to each camera;
determine that the moving direction of the person being monitored corresponding to each camera is toward the entrance if the height of the person being monitored in the created successive 3D scene models corresponding to each camera gradually increases; and
determine that the moving direction of the person being monitored corresponding to one of the two camera is toward the entrance if the height of the person being monitored in the created successive 3D scene models corresponding to the one camera gradually increases.

3. The automatic revolving door as described in claim 1, wherein the number of the at least one camera is one, and the direction determining module is operable to:
determine whether the height of the person being monitored in the created successive 3D scene models corresponding to one camera gradually increases when one or more persons appear in the created successive 3D scene models corresponding to the camera; and
determine that the moving direction of the person being monitored corresponding to one camera is toward the entrance if the height of each person being monitored in the created successive 3D scene models corresponding to one camera gradually increases.

4. The automatic revolving door as described in claim 2, wherein the step of “determine the successive 3D scene models corresponding to one camera when the moving direction of the person being monitored corresponding to at least one camera is toward an entrance of the automatic revolving door” in detail comprises:
determining a distance between the foot of the person being monitored and the monitoring camera if the moving direction of the person being monitored corresponding to each camera is toward the entrance, determine a horizontal distance between the person being monitored and the monitoring camera according to the formula: Z=(Y²−X²)^{1/2}, where Z represents the horizontal distance between the person being monitored and the monitoring camera; Y represents the distance between the foot of the person being monitored and the monitoring camera; and X represents the vertical distance between the camera and the ground; and
determining a shorter horizontal distance between the person being monitored and the monitoring camera from the determined horizontal distances, and determine the successive 3D scene models corresponding to one camera according to the shorter horizontal distance between the person being monitored and the monitoring camera.

5. The automatic revolving door as described in claim 2, wherein the step “determine the successive 3D scene models corresponding to one camera when the moving direction of the person being monitored corresponding to at least one camera is toward an entrance of the automatic revolving door” in detail comprises:
determining the successive 3D scene models corresponding to one camera if the moving direction of the person being monitored corresponding to one camera is toward the entrance.

6. The automatic revolving door as described in claim 3, wherein the step “determine the successive 3D scene models corresponding to one camera when the moving direction of the person being monitored corresponding to at least one camera is toward an entrance of the automatic revolving door” in detail comprises:
determining the successive 3D scene models corresponding to the camera if the moving direction of the person being monitored corresponding to the camera is toward the entrance.

7. The automatic revolving door as described in claim 1, wherein the detecting module is operable to:
extract data from each created successive 3D scene model corresponding to each camera corresponding to the shape of the one or more objects appearing in the corresponding created 3D scene model, and compare each of the extracted data from each created successive 3D scene model corresponding to each camera with characteristic features of each of the 3D models of persons, to determine whether one or more persons appear in the created successive 3D scene models corresponding to each camera;
determine that one or more persons appear in the created successive 3D scene models corresponding to each camera if at least one extracted data from each successive 3D scene model corresponding to each camera matches the characteristic features of any one of the 3D models of persons;
determine that one or more persons appear in the created successive 3D scene models corresponding to one camera if the least one extracted data from each successive 3D scene model corresponding to one camera matches the characteristic features of any one of the 3D models of persons; and
determine that no body appears in the created successive 3D scene models corresponding to any camera if the at least one extracted data from each successive 3D scene model corresponding to any camera does not matches the characteristic features of any one of the 3D models of persons.

8. An automatic revolving door control method implemented by an automatic revolving door, the automatic revolving door comprising at least one camera, the method comprising:
obtaining a preset number of successive images captured by each of the at least one camera, the images comprising a distance information indicating distances between each of the at least camera and objects captured by the corresponding camera;
creating successive 3D scene models corresponding to each of the at least one camera according to the preset number of successive images captured by each of the at least one camera and the distances between each of the at least one camera and any object in the field of view of the corresponding camera;
determining whether one or more persons appear in the created successive 3D scene models corresponding to each of the at least one camera according to stored 3D models of persons;
determining a foremost person of the one or more persons to be a person being monitored when the one or more persons appear in the created successive 3D scene models corresponding to at least one camera, and determining whether the moving direction of the person being monitored corresponding to at least one camera is toward an entrance of an automatic revolving door according to the created successive 3D scene models corresponding to at least one camera;
determining the successive 3D scene models corresponding to one camera when the moving direction of the person being monitored corresponding to at least one camera is toward an entrance of the automatic revolving door, selecting any two created 3D scene models from the created successive 3D scene models corresponding to the camera; determining a distance between the camera and a foot of the person being monitored included in each of the two selected 3D scene models; and determining a distance between the person being monitored and the entrance in each of the two selected 3D scene models according to the formula: β=(α²−X²)^{1/2}, where β represents the distance between the person being monitored in each of the two selected 3D scene models and the entrance; α represents the distance between the camera and the foot of the person being monitored included in each of the two selected 3D scene models; and X represents a stored vertical distance between the camera and the ground;
determining the moved distance by the person being monitored in the two selected 3D scene models being the absolute value of the difference of two determined distances between the person being monitored and the entrance in each two selected 3D scene models;
determining a moving time passed while the person being monitored moves the moved distance according to the number of 3D scene models between the two selected 3D scene models and a stored shooting speed of the camera, and further determining the moving speed of the person being monitored according to the formula: V=S/T, where V represents the moving speed of the person being monitored; S represents the moved distance by the person being monitored in the two selected 3D scene models; T represents the moving time of the person being monitored; and
controlling the automatic revolving door to rotate to match the determined moving speed of the person being monitored.

9. The automatic revolving door control method as described in claim 8, the number of the at least one camera being two and the two cameras respectively facing opposite directions, wherein the method further comprises:
determining whether the height of the person being monitored in the created successive 3D scene models corresponding to each camera gradually increases when one or more persons appear in the created successive 3D scene models corresponding to each camera;
determining that the moving direction of the person being monitored corresponding to each camera is toward the entrance if the height of the person being monitored in the created successive 3D scene models corresponding to each camera gradually increases; and
determining that the moving direction of the person being monitored corresponding to one of the two camera is toward the entrance if the height of the person being monitored in the created successive 3D scene models corresponding to the one camera gradually increases.

10. The automatic revolving door control method as described in claim 8, the number of the at least one camera being one, wherein the method further comprises:
determining whether the height of the person being monitored in the created successive 3D scene models corresponding to one camera gradually increases when one or more persons appear in the created successive 3D scene models corresponding to the camera; and
determining that the moving direction of the person being monitored corresponding to the camera is toward the entrance if the height of each person being monitored in the created successive 3D scene models corresponding to one camera gradually increases.

11. The automatic revolving door as described in claim 9, wherein the method further comprises:
determining a distance between the foot of the person being monitored and the monitoring camera if the moving direction of the person being monitored corresponding to each camera is toward the entrance, determining a horizontal distance between the person being monitored and the monitoring camera according to the formula: Z=(Y²−X²)^{1/2}, where Z represents the horizontal distance between the person being monitored and the monitoring camera; Y represents the distance between the foot of the person being monitored and the monitoring camera; and X represents the vertical distance between the camera and the ground; and
determining a shorter horizontal distance between the person being monitored and the monitoring camera from the determined horizontal distance, and determining the successive 3D scene models corresponding to one camera according to the shorter horizontal distance between the person being monitored and the monitoring camera.

12. The automatic revolving door control method as described in claim 9, wherein the method further comprises:
determining the successive 3D scene models corresponding to one camera if the moving direction of the person being monitored corresponding to one camera is toward the entrance.

13. The automatic revolving door control method as described in claim 10, wherein the method further comprises:
determining the successive 3D scene models corresponding to the camera if the moving direction of the person being monitored corresponding to the camera is toward the entrance.

14. The automatic revolving door control method as described in claim 7, wherein the method further comprises:
extracting data from each created successive 3D scene model corresponding to each camera corresponding to the shape of the one or more objects appearing in the corresponding created 3D scene model, and comparing each of the extracted data from each created successive 3D scene model corresponding to each camera with characteristic features of each of the 3D models of persons, to determine whether one or more persons appear in the created successive 3D scene models corresponding to each camera;
determining that one or more persons appear in the created successive 3D scene models corresponding to each camera if at least one extracted data from each successive 3D scene model corresponding to each camera matches the characteristic features of any one of the 3D models of persons;
determining that one or more persons appear in the created successive 3D scene models corresponding to one camera if the least one extracted data from each successive 3D scene model corresponding to one camera matches the characteristic features of any one of the 3D models of persons; and
determining that no body appears in the created successive 3D scene models corresponding to any camera if the at least one extracted data from each successive 3D scene model corresponding to any camera does not matches the characteristic features of any one of the 3D models of persons.

15. A non-transitory storage medium storing a set of instructions, the set of instructions capable of being executed by a processor of an automatic revolving door, cause the automatic revolving door to perform an automatic revolving door control method, the automatic revolving door method comprising at least one camera, the method comprising:
obtaining a preset number of successive images captured by each of the at least one camera, the images comprising a distance information indicating distances between each of the at least camera and objects captured by the corresponding camera;
creating successive 3D scene models corresponding to each of the at least one camera according to the preset number of successive images captured by each of the at least one camera and the distances between each of the at least one camera and any object in the field of view of the corresponding camera;
determining whether one or more persons appear in the created successive 3D scene models corresponding to each of the at least one camera according to stored 3D models of persons;
determining a foremost person of the one or more persons to be a person being monitored when the one or more persons appear in the created successive 3D scene models corresponding to at least one camera, and determining whether the moving direction of the person being monitored corresponding to at least one camera is toward an entrance of an automatic revolving door according to the created successive 3D scene models corresponding to at least one camera;
determining the successive 3D scene models corresponding to one camera when the moving direction of the person being monitored corresponding to at least one camera is toward an entrance of the automatic revolving door, selecting any two created 3D scene models from the created successive 3D scene models corresponding to the camera; determining a distance between the camera and a foot of the person being monitored included in each of the two selected 3D scene models; and determining a distance between the person being monitored and the entrance in each two selected 3D scene models according to the formula: β=(α²−²)^{1/2}, where β represents the distance between the person being monitored in each of the two selected 3D scene models and the entrance; α represents the distance between the camera and the foot of the person being monitored included in each of the two selected 3D scene models; and X represents a stored vertical distance between the camera and the ground;
determining the moved distance by the person being monitored in the two selected 3D scene models being the absolute value of the difference of two determined distances between the person being monitored and the entrance in each two selected 3D scene models;
determining a moving time passed while the person being monitored moves the moved distance according to the number of 3D scene models between the two selected 3D scene models and a stored shooting speed of the camera, and further determining the moving speed of the person being monitored according to the formula: V=S/T, where V represents the moving speed of the person being monitored; S represents the moved distance by the person being monitored in the two selected 3D scene models; T represents the moving time of the person being monitored; and
controlling the automatic revolving door to rotate to match the moving speed of the person being monitored.

16. The non-transitory storage medium as described in claim 15, the number of the at least one camera being two and the two cameras respectively facing opposite directions, wherein the method further comprises:
determining whether the height of the person being monitored in the created successive 3D scene models corresponding to each camera gradually increases when one or more persons appear in the created successive 3D scene models corresponding to each camera;
determining that the moving direction of the person being monitored corresponding to each camera is toward the entrance if the height of the person being monitored in the created successive 3D scene models corresponding to each camera gradually increases; and
determining that the moving direction of the person being monitored corresponding to one of the camera is toward the entrance if the height of the person being monitored in the created successive 3D scene models corresponding to the one camera gradually increases.

17. The non-transitory storage medium as described in claim 15, the number of the at least one camera being one, wherein the method further comprises:
determining whether the height of the person being monitored in the created successive 3D scene models corresponding to one camera gradually increases when one or more persons appear in the created successive 3D scene models corresponding to the camera; and
determining that the moving direction of the person being monitored corresponding to the camera is toward the entrance if the height of each person being monitored in the created successive 3D scene models corresponding to one camera gradually increases.

18. The non-transitory storage medium as described in claim 16, wherein the method further comprises:
determining a distance between the foot of the person being monitored and the monitoring camera if the moving direction of the person being monitored corresponding to each camera is toward the entrance, determining a horizontal distance between the person being monitored and the monitoring camera according to the formula: Z=(Y²−X²)^{1/2}, where Z represents the horizontal distance between the person being monitored and the monitoring camera; Y represents the distance between the foot of the person being monitored and the monitoring camera; and X represents the vertical distance between the camera and the ground; and
determining a shorter horizontal distance between the person being monitored and the monitoring camera from the determined horizontal distance, and determining the successive 3D scene models corresponding to one camera according to the shorter horizontal distance between the person being monitored and the monitoring camera.

19. The non-transitory storage medium as described in claim 16, wherein the method further comprises:
determining the successive 3D scene models corresponding to one camera if the moving direction of the person being monitored corresponding to one camera is toward the entrance.

20. The non-transitory storage medium as described in claim 15, wherein the method further comprises:
extracting data from each created successive 3D scene model corresponding to each camera corresponding to the shape of the one or more objects appearing in the corresponding created 3D scene model, and comparing each of the extracted data from each created successive 3D scene model corresponding to each camera with characteristic features of each of the 3D models of persons, to determine whether one or more persons appear in the created successive 3D scene models corresponding to each camera;
determining that one or more persons appear in the created successive 3D scene models corresponding to each camera if at least one extracted data from each successive 3D scene model corresponding to each camera matches the characteristic features of any one of the 3D models of persons;
determining that one or more persons appear in the created successive 3D scene models corresponding to one camera if the least one extracted data from each successive 3D scene model corresponding to one camera matches the characteristic features of any one of the 3D models of persons; and
determining that no body appears in the created successive 3D scene models corresponding to any camera if the at least one extracted data from each successive 3D scene model corresponding to any camera does not matches the characteristic features of any one of the 3D models of persons.
